(19) United States
(12) Patent Application Publication
(10) Pub. No.: US 2011/0143215 A1
(43) Pub. Date: Jun. 16, 2011

(54) NONAQUEOUS ELECTROLYTE SECONDARY BATTERY

(75) Inventor: Kazushi Andou, Itano-gun (JP)

(73) Assignee: SANYO ELECTRIC CO., LTD., Osaka (JP)

(21) Appl. No.: 12/960,999

(22) Filed: Dec. 6, 2010

(30) Foreign Application Priority Data
Dec. 11, 2009 (JP) 2009-281537

(51) Int. Cl. H01M 10/056

(52) U.S. Cl. 429/325

(57) ABSTRACT

Provided is a nonaqueous electrolyte secondary battery that is less likely to cause positive electrode degradation due to storage at high temperature in a charged state and has superior remaining capacity, recovering capacity, and discharge characteristics after storage at high temperature. The nonaqueous electrolyte secondary battery according to an aspect of the invention includes a positive electrode, a negative electrode, a separator, and a nonaqueous electrolyte. The nonaqueous electrolyte contains at least LiPF₆. The nonaqueous electrolyte also contains a dinitrile compound represented by Chemical Formula NC—R—CN (where R is a saturated straight chain hydrocarbon group) and magnesium hydroxide. The number of carbon atoms of the saturated straight chain hydrocarbon group R in the dinitrile compound is preferably 5 to 10.

### TECHNICAL FIELD

The present invention relates to a nonaqueous electrolyte secondary battery and, in particular, relates to a nonaqueous electrolyte secondary battery that is less likely to cause positive electrode degradation due to storage at high temperature in a charged state and has superior remaining capacity, recovering capacity, and discharge characteristics after storage at high temperature.

### BACKGROUND ART

Recently, as power supplies for driving portable electronic equipment, such as cell phones, portable personal computers, and portable music players, and further, as power supplies for hybrid electric vehicles (HEVs) and electric vehicles (EVs), nonaqueous electrolyte secondary batteries represented by lithium ion secondary batteries having high energy density and high capacity are widely used.

As for the positive electrode active material in these nonaqueous electrolyte secondary batteries, one of or a mixture of a plurality of LiCoO₂, LiNiO₂, LiNiₓCo₁₋ₓO₂(x=0.01 to 0.99), LiMnO₂, LiMn₂O₄, LiCoₓMn_{y}Ni_{z}O₂(x+y+z=1), LiFePO₄, and the like, all of which can absorb and desorb lithium ions reversibly, is used.

Among them, lithium-cobalt composite oxides and other metallic element-containing lithium-cobalt composite oxides are primarily used because their battery characteristics in various aspects are especially higher than those of other oxides. However, cobalt is expensive, and the amount of cobalt is small in natural resources. Thus, in order to continue to use such lithium-cobalt composite oxides and other metallic element-containing lithium-cobalt composite oxides as the positive electrode active material of a nonaqueous electrolyte secondary battery, the nonaqueous electrolyte secondary battery is desired to have higher performance.

Meanwhile, when a nonaqueous electrolyte secondary battery is stored in a charged state at high temperature, the positive electrode is readily degraded. This is believed to be because a nonaqueous electrolyte is oxidatively decomposed on a positive electrode active material or transition-metal ions of the positive electrode active material are eluted when the nonaqueous secondary battery is stored in a charged state, and because the decomposition of a nonaqueous electrolyte and the elution of metal ions are accelerated in a high-temperature environment as compared in a normal temperature environment.

To address this issue, JP-A-2004-179146 describes an example in which various dinitrile compounds are added to a nonaqueous electrolyte to improve the cycle characteristics, battery capacity, high-temperature storage characteristics, and other characteristics of a nonaqueous electrolyte secondary battery. JP-T-2007-510270 discloses an example in which a positive electrode coated with a positive electrode active material is immersed in electrolytic liquid containing an aliphatic dinitrile compound and then subjected to high-temperature treatment. Thus, a protection film of a complex between the aliphatic dinitrile compound and a surface of the positive electrode active material is formed on the surface to improve high-temperature storage characteristics of a nonaqueous electrolyte secondary battery. JP-A-2008-108586 discloses an example in which a dinitrile compound is added to a nonaqueous electrolyte to obtain a nonaqueous electrolyte secondary battery having high capacity and superior storage characteristics and charge and discharge cycle characteristics.

In addition, JP-T-2006-526878 discloses an example in which a metal oxide such as magnesium hydroxide is added in a positive electrode binder to improve the high-temperature storage characteristics of the nonaqueous electrolyte secondary battery.

By the inventions disclosed in JP-A-2004-179146, JP-T-2007-510270, and JP-A-2008-108586, because a dinitrile compound is adsorbed on a positive electrode in a charged state, it is considered that the compound has advantageous effects of protecting the surface of the positive electrode, reducing side reactions between a nonaqueous electrolyte and the positive electrode, and improving various types of battery characteristics when stored at high temperature. Still, even though JP-A-2004-179146, JP-T-2007-510270, and JP-A-2008-108586 describe that a long-chain dinitrile compound with a straight chain hydrocarbon group forming the dinitrile compound and having five or more carbon atoms can be used, only a short-chain dinitrile compound in which the number of carbon atoms is four or less is shown as an example with specific data.

Furthermore, especially when a nonaqueous electrolyte secondary battery, which, as in the common case, uses lithium hexafluorophosphate (LiPF₆) as an electrolyte salt in a nonaqueous electrolyte thereof, is stored under a high temperature in a charged state, following problems occur: degradation of discharge characteristics if a short-chain dinitrile compound with a saturated straight chain hydrocarbon group R having four or less carbon atoms is added in the nonaqueous electrolyte; and acceleration of self-discharge if a long-chain dinitrile compound with a straight chain hydrocarbon group R having five or more carbon atoms is added.

JP-T-2006-526878 describes how the high-temperature storage characteristics can be improved by adding magnesium hydroxide in a positive electrode binder but does not describe a case in which magnesium hydroxide is added in the nonaqueous electrolyte. Additionally, magnesium hydroxide is not related to battery reaction and thus, if the amount thereof added in the positive electrode binder increases, the battery capacity decreases.

The inventors have studied various procedures to obtain a nonaqueous electrolyte secondary battery, particularly one that uses LiPF₆ as an electrolyte salt in a nonaqueous electrolyte, is still less likely to cause positive electrode degradation due to storage at high temperature in a charged state and therefore having superior high-temperature storage characteristics. As a result, the inventors have found that the nonaqueous electrolyte secondary battery including LiPF₆ as an electrolyte salt in the nonaqueous electrolyte still achieves significantly reduced self-discharge and maintains superior discharge characteristics when the battery is stored under a high temperature in a charged state and therefore achieves superior high-temperature storage characteristics by adding magnesium hydroxide to the nonaqueous electrolyte along with a dinitrile compound. Thus, the present invention has been completed.

### SUMMARY

An advantage of some aspects of the present invention is to provide a nonaqueous electrolyte secondary battery that is less likely to cause positive electrode degradation due to storage at high temperature in a charged state and has superior remaining capacity, recovering capacity, and discharge characteristics after storage at high temperature even when LiPF₆ is included as an electrolyte salt in a nonaqueous electrolyte.

According to an aspect of the invention, a nonaqueous electrolyte secondary battery according to the present invention includes a positive electrode, a negative electrode, a separator, and a nonaqueous electrolyte. The nonaqueous electrolyte contains at least LiPF₆. The nonaqueous electrolyte also contains a dinitrile compound represented by Chemical Formula NC—R—CN (where R is a saturated straight chain hydrocarbon group) and magnesium hydroxide.

The nonaqueous electrolyte secondary battery having a superior capacity remaining rate, recovering capacity, and discharging characteristics after storage at high temperature in a charged state can be obtained if the nonaqueous electrolyte containing LiPF₆ further contains a dinitrile compound and magnesium hydroxide. The reason why such an effect can be obtained is yet to be known. Still, it is assumed that although a dinitrile compound is assumed to accelerate self-discharge in an acidic atmosphere, coexistence thereof with basic magnesium hydroxide reduces the self-discharge.

In the nonaqueous electrolyte secondary battery according to the present invention, the number of carbon atoms of the saturated straight chain hydrocarbon group R in the dinitrile compound is preferably 5 to 10.

Even if the nonaqueous electrolyte contains LiPF₆, a nonaqueous electrolyte secondary battery still having balanced positive electrode protection effect and discharge performance can be obtained by using a long chain dinitrile compound with the straight chain hydrocarbon group R having five or more carbon atoms.

The content of the dinitrile compound in the nonaqueous electrolyte secondary battery according to the present invention is preferably in the range of 0.1% to 10% by mass relative to the mass of a nonaqueous solvent in the nonaqueous electrolyte.

A content of the dinitrile compound in the nonaqueous electrolyte lower than 0.1% by mass relative to the mass of the nonaqueous solvent in the nonaqueous electrolyte is not preferable because the effect of addition of the dinitrile compound cannot be obtained. A content of the dinitrile compound in the nonaqueous electrolyte exceeding 10% by mass leads to the degradation of the discharge characteristics because the dinitrile compound is not related to the ion conductivity in the nonaqueous electrolyte and thus is not preferable. Accordingly, the content of the dinitrile compound in the nonaqueous electrolyte secondary battery according to the present invention is preferably set to be in the range of 0.1% to 10% by mass relative to the mass of the nonaqueous solvent in the nonaqueous electrolyte. Thus, a nonaqueous electrolyte secondary battery can be obtained having a superior capacity remaining rate, recovering capacity, and discharge characteristics after storage at high temperature in a charged state.

The content of magnesium hydroxide in the nonaqueous electrolyte secondary battery according to the present invention is preferably in the range of 0.1% to 5% by mass relative to the mass of a nonaqueous solvent in the nonaqueous electrolyte.

A content of magnesium hydroxide in the nonaqueous electrolyte lower than 0.1% by mass relative to the mass of the nonaqueous solvent in the nonaqueous electrolyte is not preferable because the effect of addition of the magnesium hydroxide cannot be obtained. A content of magnesium hydroxide in the nonaqueous electrolyte exceeding 5% by mass leads to the degradation of the discharge characteristics because magnesium hydroxide is not related to the ion conductivity in the nonaqueous electrolyte and thus is not preferable. Accordingly, the content of magnesium hydroxide in the nonaqueous electrolyte secondary battery according to the present invention is preferably set to be in the range of 0.1% to 5% by mass relative to the mass of the nonaqueous solvent in the nonaqueous electrolyte. Thus, a nonaqueous electrolyte secondary battery having a superior capacity remaining rate, recovering capacity, and discharge characteristics after storage at high temperature in a charged state can be obtained.

### BRIEF DESCRIPTION OF THE DRAWINGS

The invention will be described with reference to the accompanying drawing.

FIG. 1 is a perspective view showing a longitudinal section of a cylindrical-shaped nonaqueous electrolyte secondary battery used for measuring various types of battery characteristics in each example and comparative examples.

### DESCRIPTION OF EXEMPLARY EMBODIMENTS

Exemplary embodiments of the invention will now be described in detail with reference to examples and comparative examples. It should be noted that the examples described below are illustrative examples of nonaqueous electrolyte secondary batteries for embodying the technical spirit of the invention and are not intended to limit the invention to these examples, and the invention may be equally applied to various modified cases without departing from the technical spirit described in the claims.

Preparation of Positive Electrode

Ninety percent by mass of lithium cobaltate (LiCoO₂) as a positive electrode active material, 5% by mass of carbon powder as a conductive material, and 5% by mass of polyvinylidene fluoride (PVdF) powder as a binding agent were mixed and then the whole was mixed with a solution of N-methylpyrrolidone (NMP) to prepare slurry. The slurry was coated on both sides of an aluminum positive electrode current collector with a thickness of 12 μm by doctor-blade method to form positive electrode mixture layers on the positive electrode current collector. Subsequently, the positive electrode mixture layers were compressed with a compression roller to 160 μm to manufacture a positive electrode plate with a short-side length of 55 mm and a long-side length of 500 mm to be commonly used in Examples 1 to 5 and Comparative Examples 1 to 4.

Preparation of Negative Electrode

A negative electrode plate was prepared as follows. Ninety-five percent by mass of negative electrode active material formed of graphite powder, 3% by mass of thickener formed of carboxymethylcellulose (CMC), and 2% by mass of a binding agent formed of styrene-butadiene rubber (SBR) were mixed and then the whole was mixed with appropriate amount of water to prepare slurry. The slurry was coated on both sides of a copper negative electrode current collector with a thickness of 8 μm by doctor-blade method to form negative electrode mixture layers on the negative electrode current collector. Then, the resultant object was passed through a drier to be dried. Subsequently, the negative electrode mixture layers were compressed with a compression roller to 155 μm to manufacture a negative electrode plate with a short side length of 57 mm and a long side length of 550 mm to be commonly used in Examples 1 to 5 and Comparative Examples 1 to 4. The potential of the graphite is 0.1 V based on lithium. The amounts of positive electrode active material and negative electrode active material to be filled were adjusted to create a charging capacity rate between the positive electrode and the negative electrode (the negative electrode charging capacity/the positive electrode charging capacity) of 1.1 at the potential of the positive electrode active material used as a design standard.

Preparation of Nonaqueous Electrolyte

Nonaqueous solvent, mixed 30 parts ethylene carbonate (EC) to 70 parts dimethyl carbonate (DMC) by volume (25° C.), was prepared. Then, various dinitrile compounds NC—R—CN (where R is a saturated straight chain hydrocarbon group having four to eight carbon atoms) and magnesium hydroxide (Mg(OH)₂) were added thereto in the mass ratios (mass ratio relative to the solvent) described below. Furthermore, LiPF₆ as an electrolyte salt was dissolved therein so as to be 1 mol/L to provide a nonaqueous electrolyte for manufacturing the batteries.

Preparation of Battery

A rolled electrode assembly was manufactured by rolling the positive electrode plate and the negative electrode plate manufactured as above and a separator formed of polypropylene microporous membrane interposing therebetween into a cylindrical shape. The rolled electrode assembly was inserted in a cylindrical-shaped battery outer can. The nonaqueous electrolyte was injected through an opening of the battery outer can and then the battery outer can was sealed with a current interrupting sealing body. Thus, the nonaqueous electrolyte secondary battery of each of Examples 1 to 4 and Comparative Examples 1 to 4 was manufactured. The obtained nonaqueous electrolyte secondary battery has a height of 650 mm and a diameter of 18 mm and a design capacity of 2700 mAh at a charging voltage of 4.2 V.

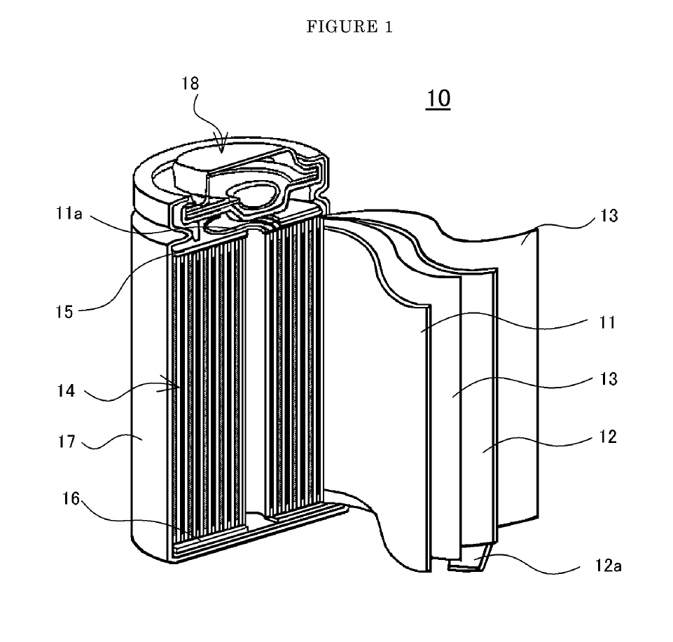

FIG. 1 is a perspective view showing a longitudinal section of a cylindrical-shaped nonaqueous electrolyte secondary battery used for measuring various types of battery characteristics in examples 1 to 5 and comparative examples 1 to 4. This nonaqueous electrolyte secondary battery 10 uses a rolled electrode assembly 14 formed by rolling a positive electrode 11 and a negative electrode 12 with a separator 13 interposed therebetween and has the following structure: insulting plates 15 and 16 are placed on upper and lower faces of the rolled electrode assembly 14, respectively. The rolled electrode assembly 14 is put into a cylindrical-shaped battery outer can 17 made of steel also serving as a negative electrode terminal. A current collecting tab 12a of the negative electrode 12 is welded on an inner bottom part of the battery outer can 17. A current collecting tab 11a of the positive electrode 11 is welded on a bottom plate part of a current interrupting sealing body 18 equipped with a safety apparatus. A predetermined nonaqueous electrolyte is poured from a mouth portion of the battery outer can 17, and the battery outer can 17 is sealed with the current interrupting sealing body 18.

### Examples 1 to 5

In the course of manufacturing a battery in accordance with the above-described procedure, 3% by mass of pimelonitrile (NC—(CH₂)₅-CN) with a saturated straight chain hydrocarbon group having five carbon atoms and 1% by mass of magnesium hydroxide relative to the mass of the nonaqueous solvent were added to the nonaqueous electrolyte to manufacture the battery of Example 1. Similarly, 10% by mass of pimelonitrile and 1% by mass of magnesium hydroxide were added to manufacture the battery of Example 2. Furthermore, 3% by mass of pimelonitrile and 5% by mass of magnesium hydroxide were added to manufacture the battery of Example 3. Three percent by mass of sebaconitrile (NC—(CH₂)₈-CN) with a saturated straight chain hydrocarbon group having eight carbon atoms and 1% by mass of magnesium hydroxide relative to the mass of the nonaqueous solvent were added to the nonaqueous electrolyte to manufacture the battery of Example 4. Similarly, 3% by mass of adiponitrile (NC—(CH₂)₄-CN) with a saturated straight chain hydrocarbon group having four carbon atoms and 1% by mass of magnesium hydroxide were added to manufacture the battery of Example 5.

### Comparative Examples 1 to 4

In the course of manufacturing a battery in accordance with the above-described procedure, neither dinitrile compound nor magnesium hydroxide was added to the nonaqueous electrolyte to manufacture the battery of Comparative Example 1. Similarly, 3% by mass of pimelonitrile was added and no magnesium hydroxide was added to manufacture the battery of Comparative Example 2. Similarly, 3% by mass of adiponitrile was added and no magnesium hydroxide was added to manufacture the battery of Comparative Example 3. Furthermore, 3% by mass of sebaconitrile was added and no magnesium hydroxide was added to manufacture the battery of Comparative Example 4.

Measurement of High-Temperature Storage Characteristics

High-temperature storage characteristics of each of the batteries of Examples 1 to 5 and Comparative Examples 1 to 4 were measured as follows. Each of the batteries was charged at 25° C. and at a constant current of 1 It=2700 mA until the battery voltage reached 4.2 V, and after reaching the battery voltage of 4.2 V, the battery was charged at a constant voltage of 4.2 V until the charging current reached 1/50 It=54 mA. Thus, the batteries were fully charged. Then, each of the batteries was discharged at a constant current of 1 It until the battery voltage decreased to 2.75 V and the discharging capacity at that point was measured as an initial discharging capacity.

Then, each of the batteries whose initial discharging capacity had been measured was again charged at 25° C. and at a constant current of 1 It until the battery voltage reached 4.2 V, and after reaching a battery voltage of 4.2 V, the battery was charged at a constant voltage of 4.2 V until the charging current reached 1/50 It. Thus, the batteries were fully charged. Then, each of the fully charged batteries was stored in a thermostatic chamber at 60° C. for 30 days and the temperature thereof was thereafter cooled to 25° C. Then, each of the batteries was discharged at a constant current of 1 It until the battery voltage decreased to 2.75 V and the discharging capacity at that point was measured to obtain a remaining capacity (%), which is the rate of the discharging capacity after storage at high temperature to the initial discharging capacity. The remaining capacity was used to measure the self-discharging amount in storage at high temperature. The larger self-discharging capacity is directly related to the lower remaining capacity. The results are shown in Table 1.

Next, positive electrode degradation due to storage at high temperature was measured as follows. Each of the batteries was charged at 25° C. and at a constant current of 1 It until the battery voltage reached 4.2 V, and after reaching a battery voltage of 4.2 V, the battery was charged at a constant voltage of 4.2 V until the charging current reached 1/50 It. Thus, the batteries were fully charged. Then, each of the fully charged batteries was discharged at a constant current of 1 It until the battery voltage has decreased to 2.75 V and the discharging capacity at this point was measured to obtain a recovering capacity (%) which is the rate of the discharging capacity at this point to the initial discharging capacity. The recovering capacity was used to measure the level of positive electrode degradation due to storage at high temperature. The larger positive electrode degradation is directly related to the lower recovering capacity. The results are shown in Table 1.

Next, discharging characteristics (load characteristics) were measured as follows. Each of the batteries whose recovering capacity had been measured was charged at 25° C. and at a constant current of 1 It until the battery voltage reached 4.2 V, and after reaching a battery voltage of 4.2 V, the battery was charged at a constant voltage of 4.2 V until the charging current reached 1/50 It. Thus, the batteries were fully charged. Then, each of the fully charged batteries was discharged at a constant current of 2 It=5400 mA until the battery voltage decreased to 2.75 V and the discharging capacity at that point was measured to obtain the discharging characteristics (%) which is the rate of the discharging capacity at this point (discharged at 2 It) to the recovering capacity (discharged at 1 It). The results are shown in Table 1.

TABLE 1

| | Amount of dinitrile compound added | | | Amount of | High-temperature | | | | Discharging | |
|---|---|---|---|---|---|---|---|---|---|---|
| | Adiponitrile | Pimelonitrile | Sebaconitrile | magnesium | storage characteristics | | | | characteristics | |
| | (R having 4 | (R having 5 | (R having 8 | hydroxide | Remaining | | Recovering | | after | |
| | carbon | carbon | carbon | added | capacity | | capacity | | storing | |
| Specification | atoms) | atoms) | atoms) | (mass %) | (%) | | (%) | | (2It/1It (%)) | |
| Example 1 | — | 3% | — | 1% | 86% | ◯ | 92% | ◯ | 90% | ◯ |
| Example 2 | — | 10% | — | 1% | 85% | ◯ | 91% | ◯ | 88% | ◯ |
| Example 3 | — | 3% | — | 5% | 88% | ◯ | 91% | ◯ | 88% | ◯ |
| Example 4 | — | — | 3% | 1% | 87% | ◯ | 92% | ◯ | 90% | ◯ |
| Example 5 | 3% | — | — | 1% | 76% | Δ | 91% | ◯ | 85% | Δ |
| Comparative | — | — | — | — | 79% | Δ | 87% | Δ | 86% | Δ |
| Example 1 | | | | | | | | | | |
| Comparative | — | 3% | — | — | 62% | X | 92% | ◯ | 89% | ◯ |
| Example 2 | | | | | | | | | | |
| Comparative | 3% | — | — | — | 74% | Δ | 93% | ◯ | 83% | X |
| Example 3 | | | | | | | | | | |
| Comparative | — | — | 3% | — | 60% | X | 92% | ◯ | 91% | ◯ |
| Example 4 | | | | | | | | | | |

The results shown in Table 1 reveal the following. The following can be found from a comparison between the results of Comparative Examples 1 and 3. The higher recovering capacity and lower discharging characteristics after storage at high temperature and the remaining capacity were obtained in the case in which only adiponitrile with a saturated straight chain hydrocarbon group having four carbon atoms is added (Comparative Example 3) as compared with those obtained in the case where no dinitrile compound was added (Comparative Example 1).

The following can be found from a comparison of the results of Comparative Examples 1, 2 and 4. Higher recovering capacity and the discharging characteristics after storage and significantly lower remaining capacity were obtained in the case where a dinitrile compound with a saturated straight chain hydrocarbon group having five or more carbon atoms is added (Comparative Examples 2 and 4) as compared with those obtained in the case where no dinitrile compound was added (Comparative Example 1).

The comparison between the results of Comparative Examples 2 and 4 shows that, provided that the number of carbon atoms of a saturated straight chain hydrocarbon group of a dinitrile compound is five or more, the larger number of carbon atoms of a saturated linear chain hydrocarbon was not related to the recovering capacity but was related to the higher discharging characteristics after storage and the lower remaining capacity. This indicates that if the number of carbon atoms of a saturated straight chain hydrocarbon group of a dinitrile compound is five or more, an increase in the number of atoms of a saturated straight chain hydrocarbon group causes the acceleration of self-discharge. All things considered, in the nonaqueous electrolyte secondary battery containing lithium hexafluorophosphate in the nonaqueous electrolyte, the number of carbon atoms of a saturated straight chain hydrocarbon group of a dinitrile compound is preferably 10 or less.

In Example 1 where pimelonitrile, i.e., a dinitrile compound with a saturated straight chain hydrocarbon group having five carbon atoms, and magnesium hydroxide were added, the recovering capacity and the discharging characteristics after storage were maintained at the same level as those in the case where only pimelonitrile was added (Comparative Example 2). Furthermore, the higher remaining capacity was obtained in Example 1 as compared with the cases where only pimelonitrile was added Comparative Example 2) and where no dinitrile compound was added (Comparative Example 1).

In Example 4 where sebaconitrile with a saturated straight chain hydrocarbon group having eight carbon atoms and magnesium hydroxide were added, the recovering capacity and the discharging characteristics after storage were maintained at the same level as those in the case where only sebaconitrile was added (Comparative Example 4). Furthermore, a higher remaining capacity was obtained in Example 4 as compared with the cases where only sebaconitrile was added (Comparative Example 4) and where no dinitrile compound was added (Comparative Example 1).

In Example 5 where adiponitrile with a saturated straight chain hydrocarbon group having four carbon atoms and magnesium hydroxide were added, the following results were obtained.

(1) The recovering capacity was substantially the same as the case where only adiponitrile was added (Comparative Example 3), but was superior to the case where no dinitrile compound was added (Comparative Example 1).
(2) Both the remaining capacity and the discharging characteristics after storage were slightly superior to the case where only adiponitrile was added (Comparative Example 3), but was slightly inferior to the case where no dinitrile compound was added (Comparative Example 1).

The comparisons among Examples 1, 4, and 5, in which only the numbers of carbon atoms of a saturated straight chain hydrocarbon group are different, reveal the following. In each of Examples 1 and 4 in which the number of carbon atoms of a saturated straight chain hydrocarbon group is five or more, the recovering capacity was substantially the same and the remaining capacity and the discharging characteristics after storage were higher as compared with those in Example 5 in which the number of carbon atoms is four. Moreover, substantially the same characteristics were obtained in Examples 1 and 4 where the numbers of carbon atoms of a saturated straight chain hydrocarbon group are five and eight, respectively.

Reasonably judging from the above results, the addition of both dinitrile compound and magnesium hydroxide can provide a nonaqueous electrolyte secondary battery with less self-discharge and superior characteristics as compared with the case where only a dinitrile compound is added. Self-discharge can be even further reduced by adding a dinitrile compound with a saturated straight chain hydrocarbon group having five or more carbon atoms along with magnesium hydroxide. The number of carbon atoms of a saturated straight chain hydrocarbon group is preferably 10 or less considering the fact that an increase in the number of carbon atoms of a saturated straight chain hydrocarbon group tends to increase the self-discharge.

The comparison between Examples 1 and 2, in which the amounts of magnesium hydroxide added were the same and only the amounts of pimelonitrile added were different, reveals the following. Although the increase in amount of pimelonitrile added is accompanied by the gradual degradation of the remaining capacity, the recovering capacity, and the discharge characteristics, good results can be obtained as long as the amount of pimelonitrile added is 10% by mass or lower relative to the mass of the nonaqueous solvent in the nonaqueous electrolyte. According to the results of a separately performed experiment, the dinitrile compound addition was found to be effective if the amount of dinitrile compound added is 0.1% by mass or more. Accordingly, the preferable amount of dinitrile compound added is in the range of 0.1% to 10% by mass relative to the mass of the nonaqueous solvent in the nonaqueous electrolyte.

The comparison between Examples 1 and 3, in which the amounts of pimelonitrile added were the same and only amounts of magnesium hydroxide added were different, reveals the following. Although the increase in amount of magnesium hydroxide added is accompanied by the gradual degradation of remaining capacity, the recovering capacity, and the discharge characteristics, good results can be obtained at least as long as the amount of magnesium hydroxide added is 5% by mass or lower relative to the mass of the nonaqueous solvent in the nonaqueous electrolyte. According to the results of a separately performed experiment, the magnesium hydroxide addition was found to be effective if the amount of magnesium hydroxide added is 0.1% by mass or more. Accordingly, the preferable amount of magnesium hydroxide added is in the range of 0.1% to 5% by mass relative to the mass of the nonaqueous solvent in the nonaqueous electrolyte.

To summarize the above results, it is clear that the addition of both a dinitrile compound and magnesium hydroxide to a nonaqueous electrolyte, at least containing LiPF₆, in a nonaqueous electrolyte secondary battery results in superior remaining capacity, recovering capacity, and discharge characteristics when the battery is stored under a high temperature in a charged state. The number of carbon atoms of a saturated straight chain hydrocarbon group R in the dinitrile compound is preferably in the range of 5 to 10. The content of dinitrile compound is preferably in the range of 0.1% to 10% by mass relative to the mass of a nonaqueous solvent in the nonaqueous electrolyte. The content of magnesium hydroxide is preferably in the range of 0.1% to 5% by mass relative to the mass of the nonaqueous solvent in the nonaqueous electrolyte.

What is claimed is:

1. A nonaqueous electrolyte secondary battery comprising:
a positive electrode,
a negative electrode,
a separator, and
a nonaqueous electrolyte,
the nonaqueous electrolyte containing at least lithium hexafluorophosphate, and
the nonaqueous electrolyte further containing a dinitrile compound represented by Chemical Formula NC—R—CN (where R is a saturated straight chain hydrocarbon group) and magnesium hydroxide.

2. The nonaqueous electrolyte secondary battery according to claim 1, wherein the number of carbon atoms of the saturated straight chain hydrocarbon group R in the dinitrile compound is preferably 5 to 10.

3. The nonaqueous electrolyte secondary battery according to claim 1, wherein the content of the dinitrile compound is in the range of 0.1% to 10% by mass relative to the mass of a nonaqueous solvent in the nonaqueous electrolyte.

4. The nonaqueous electrolyte secondary battery according to claim 1, wherein the content of magnesium hydroxide in the nonaqueous electrolyte is in the range of 0.1% to 5% by mass relative to the mass of a nonaqueous solvent in the nonaqueous electrolyte.
